(19) United States
(12) Patent Application Publication
(10) Pub. No.: US 2025/0308717 A1
(43) Pub. Date: Oct. 2, 2025

(54) APPARATUS FOR TESTING THERMAL-STATE CONDUCTION PERFORMANCE OF ELECTRICAL PENETRATION PIECE OF HIGH-TEMPERATURE GAS-COOLED REACTOR

(71) Applicant: Huaneng Nuclear Energy Technology Research Institute Co., Ltd., Shanghai (CN)

(72) Inventors: Miaomiao WANG, Shanghai (CN); Duo YANG, Shanghai (CN); Minghui MA, Shanghai (CN); Hai LONG, Shanghai (CN); Haosong XU, Shanghai (CN); Chuanlong TAO, Shanghai (CN); Junping HUANG, Shanghai (CN); Tianzhu WANG, Shanghai (CN); Bo MAO, Shanghai (CN)

(21) Appl. No.: 18/885,489

(22) Filed: Sep. 13, 2024

(30) Foreign Application Priority Data
Mar. 28, 2024 (CN) 202410369527.5

(51) Int. Cl. G21C 17/00; G21C 9/02

(52) U.S. Cl. CPC G21C 17/00; G21C 9/02

(57) ABSTRACT

Disclosed is an apparatus for testing the thermal-state conduction performance of an electrical penetration piece of a high-temperature gas-cooled reactor. The apparatus includes a testing mechanism. The testing mechanism includes a base, a test portion arranged on the base. According to the apparatus for testing the thermal-state conduction performance of the electrical penetration piece of the high-temperature gas-cooled reactor, a threaded rod is rotated to drive a winding column to rotate to tension an insulating rope, and the insulating rope is tensioned to drive a copper pipe to be contracted to be in close contact with pins, so that the connection of the pins of the electrical penetration piece is completed. Through the testing portion, the conduction performance of the electrical penetration piece of a primary circuit of an absorption ball system can be tested in the helium atmosphere at 160° C.

### CROSS-REFERENCE TO RELATED APPLICATIONS

The present application claims priority to Chinese Patent Application No. 2024103695275, filed on Mar. 28, 2024, the entire disclosure of which is incorporated herein by reference.

### TECHNICAL FIELD

The present invention relates to the technical field of high-temperature gas-cooled reactors, and in particular to an apparatus for testing the thermal-state conduction performance of an electrical penetration piece of a high-temperature gas-cooled reactor.

### BACKGROUND

The demonstration project of a high-temperature gas-cooled reactor nuclear power plant is the first in the world. An absorption ball shutdown system is a second shutdown system of a high-temperature gas-cooled reactor. The system includes a driving mechanism, a ball storage tank and a boron-containing absorption ball. During normal operation of the reactor, the boron-containing absorption ball is located in the ball storage tank. When the reactor is required to enter a cold shutdown mode, absorption balls are thrown, a ball falling pipe of the ball storage tank is started, the absorption balls fall into a hole channel, and the reactivity of the reactor core is reduced to a certain level. Before the reactor is started again, it is necessary to blow the absorption balls in the hole channel of the reactor core back to the ball storage tank.

A level gauge is mounted in the ball storage tank and configured to indicate the high and low levels of the boron-containing absorption balls in the ball storage tank. High and low material level signals are sent to a level gauge transmitter through an electrical penetration piece of a primary circuit, and are sent to a main control room through signal transformation.

The primary circuit of the reactor is in a high-temperature state. In the operation process of the absorption ball system, the material level signals flash many times when the temperature of the primary circuit changes, the electrical penetration piece of the primary circuit of the absorption ball system is in the form of adapting flanges, and a conductor between the adapting flanges in a hot state is expanded unevenly, so that the transmission path of the material level signals is poor in contact, and the material level signals flash. Therefore, an apparatus for testing the thermal-state conduction performance of an electrical penetration piece of a high-temperature gas-cooled reactor is required.

### SUMMARY

In view of the problems in an existing apparatus for testing the thermal-state conduction performance of an electrical penetration piece of a high-temperature gas-cooled reactor, the present invention is proposed.

Therefore, an objective of the present invention is to provide an apparatus for testing the thermal-state conduction performance of an electrical penetration piece of a high-temperature gas-cooled reactor, so as to detect the electrical penetration piece under the high-temperature state and facilitate the mounting of the electrical penetration piece.

To solve the above technical problem, the present invention provides the following technical solution: an apparatus for testing the thermal-state conduction performance of an electrical penetration piece of a high-temperature gas-cooled reactor, including:
a testing mechanism, including a base, a test portion arranged on the base, a penetration piece arranged on the test portion, a square modification portion arranged on the test portion, a supporting portion arranged in the test portion, and a conducting connection portion arranged on the supporting portion; and
a tensioning mechanism, including a winding portion arranged on the test portion, a handle portion arranged on the test portion, a limiting portion arranged on the test portion, and a testing portion arranged on the test portion.

As a preferred solution of the apparatus for testing the thermal-state conduction performance of the electrical penetration piece of the high-temperature gas-cooled reactor according to the present invention, the test portion includes a test cylinder arranged on the base, a test hole formed in the test cylinder, and a maintenance door arranged on the test cylinder.

As a preferred solution of the apparatus for testing the thermal-state conduction performance of the electrical penetration piece of the high-temperature gas-cooled reactor according to the present invention, the penetration piece includes a penetration piece body arranged on the test cylinder, pins arranged on the penetration piece body, a flange arranged on the penetration piece body, and a measuring port formed in the penetration piece body.

As a preferred solution of the apparatus for testing the thermal-state conduction performance of the electrical penetration piece of the high-temperature gas-cooled reactor according to the present invention, the square modification portion includes a square plate arranged on the test cylinder, a circular hole formed in the square plate, and a retaining ring arranged on the square plate and matched with the flange.

As a preferred solution of the apparatus for testing the thermal-state conduction performance of the electrical penetration piece of the high-temperature gas-cooled reactor according to the present invention, the supporting portion includes a supporting side plate arranged in the test cylinder, a supporting seal plate arranged on the supporting side plate, a movable groove formed in the supporting seal plate, and a penetration hole formed in the supporting seal plate and matched with the pins.

As a preferred solution of the apparatus for testing the thermal-state conduction performance of the electrical penetration piece of the high-temperature gas-cooled reactor according to the present invention, the conducting connection portion includes a copper pipe arranged in the movable groove a notch formed in the copper pipe, a cable lug arranged on the copper pipe, and an insulating rope arranged on the copper pipe.

As a preferred solution of the apparatus for testing the thermal-state conduction performance of the electrical penetration piece of the high-temperature gas-cooled reactor according to the present invention, the winding portion includes a winding column arranged in the test cylinder and connected to the insulating rope, a spline groove formed in the winding column, and a spline shaft arranged in the spline groove.

As a preferred solution of the apparatus for testing the thermal-state conduction performance of the electrical penetration piece of the high-temperature gas-cooled reactor according to the present invention, the handle portion includes a threaded sleeve arranged on the test cylinder, a threaded rod arranged on the threaded sleeve and connected to the spline shaft, and an extruding circular truncated cone arranged on the threaded rod.

As a preferred solution of the apparatus for testing the thermal-state conduction performance of the electrical penetration piece of the high-temperature gas-cooled reactor according to the present invention, the limiting portion includes a sliding block arranged on the test cylinder, a vertical rod arranged on the sliding block, a reset spring arranged on the vertical rod and connected to the threaded sleeved, a limiting strip arranged on the vertical rod, and an extruding inclined block arranged on the limiting strip and matched with the extruding circular truncated cone.

As a preferred solution of the apparatus for testing the thermal-state conduction performance of the electrical penetration piece of the high-temperature gas-cooled reactor according to the present invention, the testing portion includes a vacuum pump arranged on the test cylinder, a gas cylinder arranged on the base and connected to the test cylinder, and a constant-temperature control cabinet arranged on the test cylinder.

The present invention has the following beneficial effects: through the testing portion, the conduction performance of the electrical penetration piece of a primary circuit of an absorption ball system can be tested in the helium atmosphere at 160° C.

A threaded rod is rotated to drive a winding column to rotate to tension an insulating rope, and the insulating rope is tensioned to drive a copper pipe to be contracted to be in close contact with pins, so that the connection of the pins of the electrical penetration piece is completed. Meanwhile, the threaded rod is rotated to extrude a limiting strip to move to limit a square plate, so that the penetration piece is fixed without separate fixed operation and lead connection operation, the operation is convenient, and a certain amount of labor is saved.

### BRIEF DESCRIPTION OF DRAWINGS

To more clearly describe the technical solutions of the embodiments of the present invention, the accompanying drawings required to describe the embodiments are briefly described below. Apparently, the accompanying drawings described below are only some embodiments of the present invention. Those skilled in the art may further obtain Other drawings based on these accompanying drawings without inventive effort. In the drawings:

FIG. 1 is a schematic diagram of an overall structure of an apparatus for testing the thermal-state conduction performance of an electrical penetration piece of a high-temperature gas-cooled reactor according to the present invention;

FIG. 2 is a structural schematic diagram of a test portion of an apparatus for testing the thermal-state conduction performance of an electrical penetration piece of a high-temperature gas-cooled reactor according to the present invention;

FIG. 3 is a structural schematic diagram of a penetration piece of an apparatus for testing the thermal-state conduction performance of an electrical penetration piece of a high-temperature gas-cooled reactor according to the present invention;

FIG. 4 is a structural schematic diagram of a square modification portion of an apparatus for testing the thermal-state conduction performance of an electrical penetration piece of a high-temperature gas-cooled reactor according to the present invention;

FIG. 5 is a structural schematic diagram of a supporting portion of an apparatus for testing the thermal-state conduction performance of an electrical penetration piece of a high-temperature gas-cooled reactor according to the present invention;

FIG. 6 is a structural schematic diagram of a conducting connection portion of an apparatus for testing the thermal-state conduction performance of an electrical penetration piece of a high-temperature gas-cooled reactor according to the present invention;

FIG. 7 is a structural schematic diagram of a winding column of an apparatus for testing the thermal-state conduction performance of an electrical penetration piece of a high-temperature gas-cooled reactor according to the present invention; and

FIG. 8 is a structural schematic diagram of limiting portion of an apparatus for testing the thermal-state conduction performance of an electrical penetration piece of a high-temperature gas-cooled reactor according to the present invention.

### DETAILED DESCRIPTION OF THE EMBODIMENTS

To make the aforementioned objectives, features and advantages of the present invention more apparent and comprehensible, detailed descriptions of specific embodiments of the present invention are provided below with reference to the accompanying drawings of the specification.

A number of specific details are set forth in the description below to provide a thorough understanding for the present invention, however, the present invention may also be implemented in other manners different from those described herein, and those skilled in the art may make similar generalization without departing from the essence of the present invention, therefore, the present invention is not limited by the specific embodiments disclosed below.

Secondly, “one embodiment” or “embodiment” referred to herein refers to a specific feature, structure, or characteristic that may be included in at least one implementation manner of the present invention. The “in one embodiment” appearing in different parts of the present specification does not necessarily refer to the same embodiment, nor a separate or selective embodiment that is mutually exclusive to other embodiments.

The present invention is described in detail in conjunction with illustrations. For the convenience of description, sectional views of the device structure are partially enlarged without being drawn to scale. The illustrations are merely exemplary and should not limit the protection scope of the present invention. In addition, the three-dimensional space dimensions of length, width and depth should be included in the actual production.

### Embodiment 1

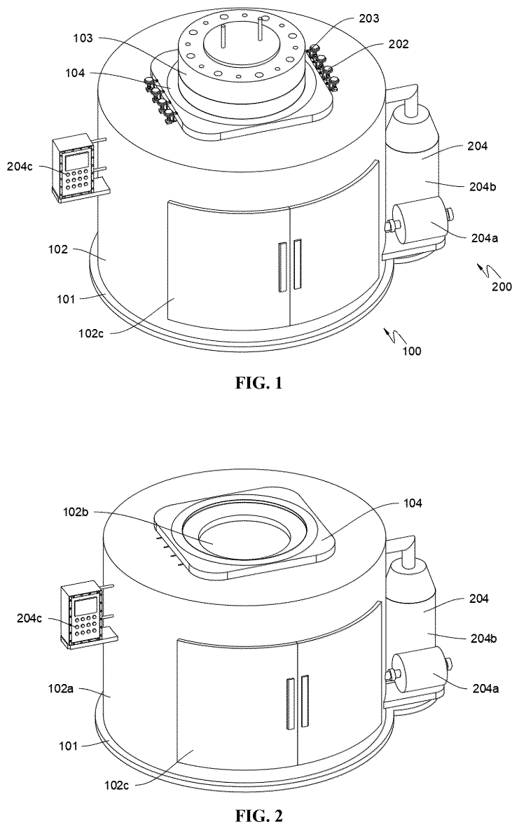

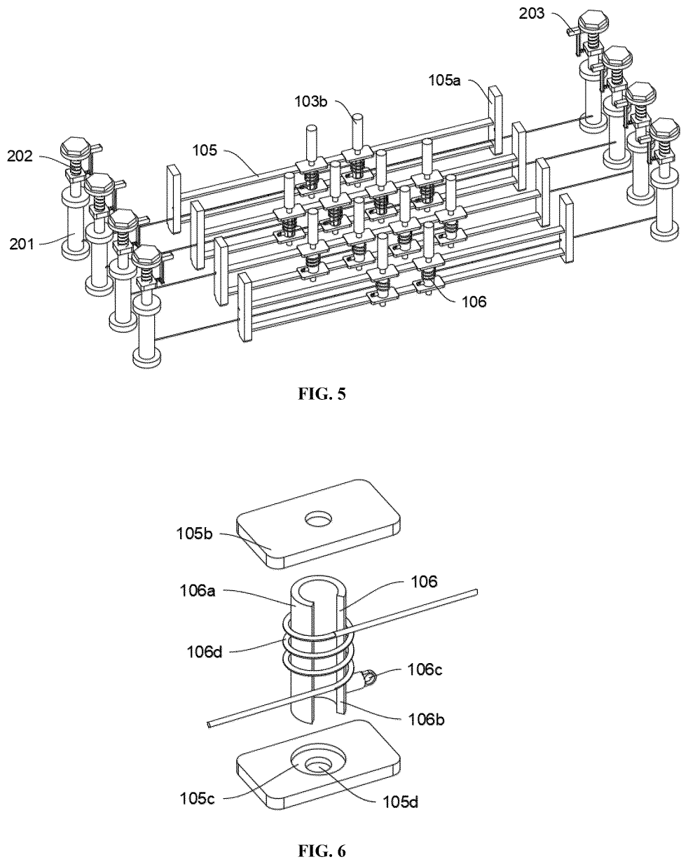

Referring to FIG. 1 and FIG. 5, as a first embodiment of the present invention, an apparatus for testing the thermal-state conduction performance of an electrical penetration piece of a high-temperature gas-cooled reactor is provided. The apparatus includes:

a testing mechanism 100, including a base 101, a test portion 102 arranged on the base 101, a penetration piece 103 arranged on the test portion 102, a square modification portion 104 arranged on the test portion 102, a supporting portion 105 arranged in the test portion 102, and a conducting connection portion 106 arranged on the supporting portion 105; and

a tensioning mechanism 200, including a winding portion 201 arranged on the test portion 102, a handle portion 202 arranged on the test portion 102, a limiting portion 203 arranged on the test portion 102, and a testing portion 204 arranged on the test portion 102.

During use, the penetration piece 103 is placed on the test portion 102, the square modification portion 104 is sleeved on the penetration piece 103, the handle portion 202 is rotated to drive the winding portion 201 to rotate, and the winding portion 201 rotates to drive the conducting connection portion 106 to be contracted to be in close contact with the penetration piece 103, so that the connection of the penetration piece 103 is completed. During rotation of the handle portion 202, the limiting portion 203 is extruded to move, the limiting portion 203 moves to limit the square modification portion 104, and the square modification portion 104 limits and fixes the penetration piece 103, so that the mounting of the penetration piece 103 is completed.

### Embodiment 2

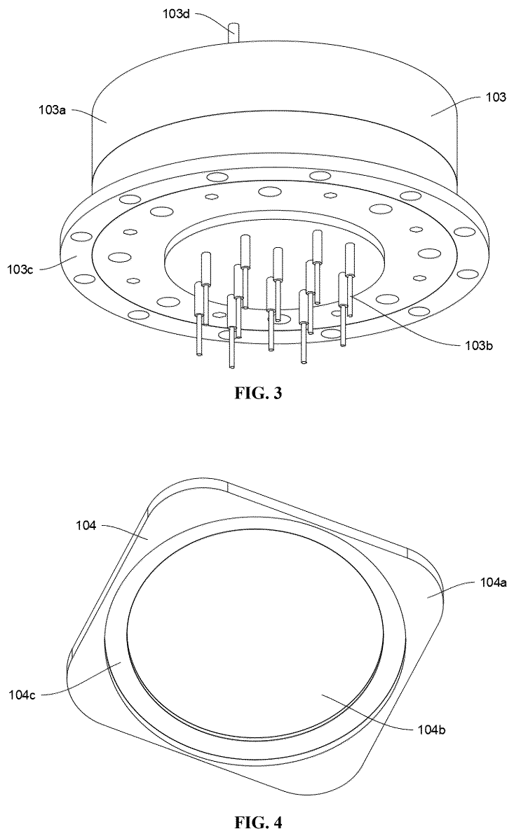

Referring to FIG. 1 to FIG. 6, as a second embodiment of the present invention, this embodiment is different from the first embodiment in that: the test portion 102 includes a test cylinder 102a arranged on the base 101, a test hole 102b formed in the test cylinder 102a, and a maintenance door 102c arranged on the test cylinder 102a.

Preferably, the test cylinder 102a is configured to bear the electrical penetration piece, the test cylinder 102a is provided with a vacuumizing and inflating interface, a pressure-guiding interface and a thermocouple mounting interface, and the test cylinder 102a should be wrapped with a heat-insulating material, thereby preventing a tester from being scalded during the test.

The penetration piece 103 includes a penetration piece body 103a arranged on the test cylinder 102a, pins 103b arranged on the penetration piece body 103a, a flange 103c arranged on the penetration piece body 103a, and a measuring port 103d formed in the penetration piece body 103a.

The square modification portion 104 includes a square plate 104a arranged on the test cylinder 102a, a circular hole 104b formed in the square plate 104a, and a retaining ring 104c arranged on the square plate 104a and matched with the flange 103c.

Preferably, the diameter of the circular hole 104b is the same as that of the flange 103c, so that the square plate 104a can be sleeved at the periphery of the flange 103c; the size of the retaining ring 104c is the same as that of the flange 103c, so that the square plate 104a can be sleeved at the periphery of the penetration piece body 103a and can extrude the flange 103c; since the square plate 104a is provided, the limiting portion 203 can move to an upper part of the square plate 104a, so that the square plate 104a can be limited, thereby fixing the penetration piece body 103a; and if the square plate 104a is provided, only part of the limiting portion 203 can move above the flange 103c to fix the penetration piece body 103a, thereby affecting the stability of the penetration piece body 103a.

The supporting portion 105 includes a supporting side plate 105a arranged in the test cylinder 102a, a supporting seal plate 105b arranged on the supporting side plate 105a, a movable groove 105c formed in the supporting seal plate 105b, and a penetration hole 105d formed in the supporting seal plate 105b and matched with the pins 103b.

Preferably, as shown in FIG. 5, the supporting side plate 105a is fixedly arranged in the test cylinder 102a and located on two sides, and is configured to mount the supporting seal plate 105b, and the supporting seal plate 105b is made of an insulating material, thereby preventing the pins 103b from being connected in series; several supporting seal plates 105b are provided, and the supporting seal plates 105b are arranged above and below the conducting connection portion 106, so that the stability of the copper pipe 106a can be improved, and the copper pipe 106a can be prevented from falling off; the movable groove 105c is configured to limit the copper pipe 106a, thereby ensuring that the copper pipe 106a can be contracted while preventing the copper pipe 106a from falling off; and the penetration hole 105d is provided, so that the pins 103b can be inserted into the copper pipe 106a, thereby ensuring the connection between the copper pipe 106a and the pins 103b.

The conducting connection portion 106 includes the copper pipe 106a arranged in the movable groove 105c, a notch 106b formed in the copper pipe 106a, a cable lug 106c arranged on the copper pipe 106a, and an insulating rope 106d arranged on the copper pipe 106a.

Preferably, the copper pipe 106a is movably arranged in the movable groove 105c; the notch 106b is provided, so that the copper pipe 106a can be contracted, thereby ensuring that the copper pipe 106a can be in close contact with the pins 103b; the cable lug 106c is configured to connect a lead in the test cylinder 102a;

the insulating rope 106d is made of an insulating material, thereby preventing the pins 103b from being connected in series; two ends of the insulating rope 106d are fixed on the winding column 201a; the copper pipe 106a located between two winding columns 201a is sequentially wound and connected through the insulating rope 106d; when the two ends of the insulating rope 106d are tensioned, since the notch 106b is provided, a tensile force of the insulating rope 106d makes the copper pipe 106a be contracted, the copper pipe 106a is contracted to be in close contact with the pins 103b to complete connection; and after the test is completed, the two ends of the insulating rope 106d are loosened, and the elastic deformation of the copper pipe 106a restores the copper pipe 106a, so that the apparatus can perform the next test conveniently.

Further, in the current mounting method, it is necessary to fix the penetration piece body 103a through a bolt, a worker enters the test cylinder 102a through the maintenance door 102c, the lead in the test cylinder 102a is wound on the pins 103b, and then the test can be performed. After the test is completed, the parts are disassembled one by one. When the test of the next penetration piece body 103a is performed, operation is repeated, and the workload is large, which affects the test efficiency.

Through the cooperation of the insulating rope 106d and the copper pipe 106a, the worker can dock the lead without entering the test cylinder 102a, and the connection of several pins 103b can be completed only by rotating the handle portion 202, so that the workload can be reduced.

The remaining structure is the same as the structure in Embodiment 1.

During use, the pins 103b on the penetration piece body 103a are inserted into the test cylinder 102a through the test hole 102b, the pins 103b are inserted into the copper pipe 106a through the penetration hole 105d at the same time, the square plate 104a is sleeved on the penetration piece body 103a after the penetration piece body 103a is placed, the retaining ring 104c is in close contact with the flange 103c at the same time, the handle portion 202 is rotated to drive the winding portion 201 to rotate, the winding portion 201 rotates to wind the winding rope 106d on the winding portion 201, the insulating rope 106d is tensioned to make the copper pipe 106a be contracted, and the copper pipe 106a is contracted to be in close contact with the pins 103b, so that the connection of the pins 103b can be completed.

### Embodiment 3

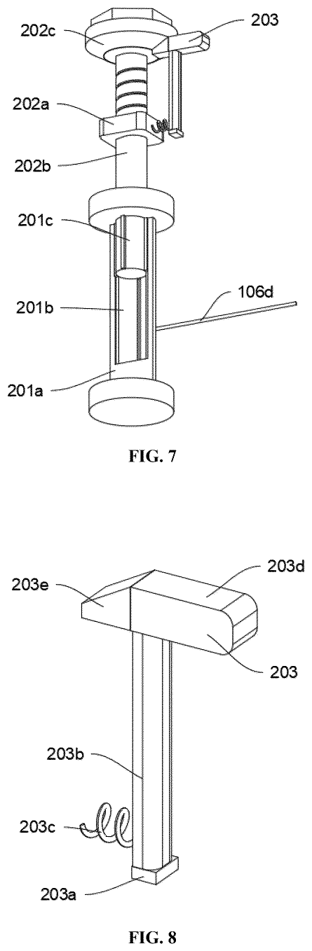

Referring to FIG. 5 to FIG. 8, as a third embodiment of the present invention, this embodiment is different from the second embodiment in that: the winding portion 201 includes a winding column 201a arranged in the test cylinder 102a and connected to the insulating rope 106d, a spline groove 201b formed in the winding column 201a, and a spline shaft 201c arranged in the spline groove 201b.

Preferably, the winding column 201a is rotatably arranged in the test cylinder 102a, and the spline groove 201b is provided, so that the spline shaft 201c can drive the winding column 201a to rotate, the descending of the threaded rod 202b is not affected, and the normal operation of the apparatus is ensured.

The handle portion 202 includes a threaded sleeve 202a arranged on the test cylinder 102a, a threaded rod 202b arranged on the threaded sleeve 202a and connected to the spline shaft 201c, and an extruding circular truncated cone 202c arranged on the threaded rod 202b.

Preferably, the threaded rod 202b is rotated to drive the winding column 201a to rotate so as to tension the insulating rope 106d; furthermore, when the threaded rod 202b is rotated, the threaded rod 202b will descend, the descending of the threaded rod 202b drives the extruding circular truncated cone 202c to descend, and the inclined surface of the extruding circular truncated cone 202c pushes an inclined surface of an extruding inclined block 203e to move an extruding inclined block 203e, so that the penetration piece body 103a can be limited and fixed, and the operation is convenient.

The limiting portion 203 includes a sliding block 203a arranged on the test cylinder 102a, a vertical rod 203b arranged on the sliding block 203a, a reset spring 203c arranged on the vertical rod 203b and connected to the threaded sleeve 202a, a limiting strip 203d arranged on the vertical rod 203b, and the extruding inclined block 203e arranged on the limiting strip 203d and matched with the extruding circular truncated cone 202c.

Preferably, a sliding groove matched with the sliding block 203a is formed at the top of the test cylinder 102a and configured to mount the sliding block 203a, so that the sliding block 203a can slide in parallel, and the normal operation of the apparatus can be ensured.

The testing portion 204 includes a vacuum pump 204a arranged on the test cylinder 102a, a gas cylinder 204b arranged on the base 101 and connected to the test cylinder 102a, and a constant-temperature control cabinet 204c arranged on the test cylinder 102a.

Preferably, a heating unit of the constant-temperature control cabinet 204c is mounted in the test cylinder 102a, the power is 12 kW, the temperature inside the test cylinder 102a can be heated to 160° C., and the constant-temperature control cabinet 204c is configured to control the power output of the heating unit to achieve constant-temperature control;

the thermal-state conduction test of the penetration piece 103 is required to be carried out in the thermal-state helium atmosphere, and the vacuum pump 204a is configured to vacuumize the interior of the test cylinder 102a to 0.01 MPa·a;

the gas cylinder 204b communicates with the test cylinder 102b, and a pressure-reducing valve and a gas pump are provided; and after the interior of the test cylinder 102a is vacuumized, helium of 0.1 MPa·a is inflated to the interior of the test cylinder 102a by the gas cylinder 204b.

The penetration piece 103 is mounted on the test cylinder 102a, the copper pipe 106a in the test cylinder 102a is connected to the pins 103b, and test is performed according to the following steps:
the vacuum pump 204a is started, the interior of the test cylinder 102a is vacuumized, the indication of a pressure gauge is observed, and when the pressure reaches 0.01 MPa·a, an inlet valve of the vacuum pump 204a is closed, and then the vacuum pump 204a is stopped;
the pressure-reducing valve at an outlet of the gas cylinder 204b and a gas inlet valve of the test cylinder 102a are opened slowly, helium is inflated into the test cylinder 102a, the indication of the pressure gauge is observed, and when the pressure reaches 0.1 MPa·a, the gas inlet valve of the test cylinder 102a and the pressure-reducing valve at the outlet of the gas cylinder 204b are closed;
the heating unit is started by the constant-temperature control cabinet 204c, and a highest temperature limit is set to 160° C.; and
the indication “the temperature of the cylinder body of the test apparatus” on the constant-temperature control cabinet 204c is observed, and when the temperature is stabilized at 160±10° C., the conduction performance of the electrical penetration piece of the primary circuit is measured at the measuring port.

The remaining structure is the same as the structure in Embodiment 2.

During use, the threaded rod 202b is rotated to drive the spline shaft 201c to rotate the winding column 201a, and the winding column 201a rotates to wind the insulating rope 106d to a surface of the winding column 201a, so that the insulating rope 106d is tensioned; the insulating rope 106d is tensioned to make the copper pipe 106a be contracted, and the copper pipe 106a is contracted to be in close contact with surfaces of the pins 103b, so that connection is completed; and the threaded rod 202b does not descend during rotation, the threaded rod 202b drives the extruding circular truncated cone 202c to descend, the extruding circular truncated cone 202c extrudes the extruding inclined block 203e to move the limiting strip 203d, and the limiting strip 203d moves above the square plate 104a, so that the square plate 104a can be limited, and the mounting of the penetration piece body 103a can be completed.

It is important to note that the configurations and arrangements of the present application shown in the various exemplary implementation schemes are merely illustrative. Although only a few implementation solutions are described in detail in the contents disclosed herein, those having reference to the contents disclosed herein should readily understand that many modifications are possible (for example, variations in the sizes, dimensions, structures, shapes and proportions of various elements, parameter values (such as temperatures and pressures), installations and arrangements, use of materials, colors, orientations, etc.), without materially departing from the novel teachings and advantages of the subject described in the present application. For example, the elements shown as integrally formed may be constructed of a plurality of parts or elements, the positions of the elements may be inverted or varied in other manners, and the properties or quantities or positions of the discrete elements may be altered or varied. Therefore, all such modifications are intended to be included within the scope of the present invention. The order or sequence of any process or method steps may be changed or re-sequenced according to alternative embodiments. In the claims, any provision of “apparatus with function” is intended to cover the structure described herein for executing the function, and is not merely structurally equivalent but also equivalent in structure. Other substitutions, modifications, variations, and omissions may be made in the design, operation conditions, and arrangements of the exemplary implementation solutions without departing from the scope of the present invention. Therefore, the present invention is not limited to the specific implementation solutions but extends to a plurality of modifications still falling within the scope of the appended claims. In addition, for a concise description of the exemplary implementation solutions, all features of actual embodiments (that is, those that are not related to the currently considered best mode for carrying out the present invention, or those that are not related to the practice of the present invention) may not be described.

It should be noted that the above embodiments are merely used to describe, but not to limit, the technical solution of the present invention. Although the present invention is described in detail with reference to the preferred embodiments, those of ordinary skill in the art should understand that the technical solution of the present invention can be modified or equivalently replaced without departing from the spirit and scope of the technical solution of the present invention, and should be included in the scope of the claims of the present invention.

What is claimed is:

1. An apparatus for testing the thermal-state conduction performance of an electrical penetration piece of a high-temperature gas-cooled reactor, comprising:
a testing mechanism, comprising a base, a test portion arranged on the base, a penetration piece arranged on the test portion, a square modification portion arranged on the test portion, a supporting portion arranged in the test portion, and a conducting connection portion arranged on the supporting portion; and
a tensioning mechanism, comprising a winding portion arranged on the test portion, a handle portion arranged on the test portion, a limiting portion arranged on the test portion, and a testing portion arranged on the test portion.

2. The apparatus for testing the thermal-state conduction performance of an electrical penetration piece of a high-temperature gas-cooled reactor according to claim 1, wherein the test portion comprises a test cylinder arranged on the base, a test hole formed in the test cylinder, and a maintenance door arranged on the test cylinder.

3. The apparatus for testing the thermal-state conduction performance of an electrical penetration piece of a high-temperature gas-cooled reactor according to claim 2, wherein the penetration piece comprises a penetration piece body arranged on the test cylinder, pins arranged on the penetration piece body, a flange arranged on the penetration piece body, and a measuring port arranged on the penetration piece body.

4. The apparatus for testing the thermal-state conduction performance of an electrical penetration piece of a high-temperature gas-cooled reactor according to claim 3, wherein the square modification portion comprises a square plate arranged on the test cylinder, a circular hole formed in the square plate, and a retaining ring arranged on the square plate and matched with the flange.

5. The apparatus for testing the thermal-state conduction performance of an electrical penetration piece of a high-temperature gas-cooled reactor according to claim 4, wherein the supporting portion comprises a supporting side plate arranged in the test cylinder, a supporting seal plate arranged on the supporting side plate, a movable groove formed in the supporting seal plate, and a penetration hole formed in the supporting seal plate and matched with the pins.

6. The apparatus for testing the thermal-state conduction performance of an electrical penetration piece of a high-temperature gas-cooled reactor according to claim 5, wherein the conducting connection portion comprises a copper pipe arranged in the movable groove, a notch formed in the copper pipe, a cable lug arranged on the copper pipe, and an insulating rope arranged on the copper pipe.

7. The apparatus for testing the thermal-state conduction performance of an electrical penetration piece of a high-temperature gas-cooled reactor according to claim 6, wherein the winding portion comprises a winding column arranged in the test cylinder and connected to the insulating rope, a spline groove formed in the winding column, and a spline shaft arranged in the spline groove.

8. The apparatus for testing the thermal-state conduction performance of an electrical penetration piece of a high-temperature gas-cooled reactor according to claim 7, wherein the handle portion comprises a threaded sleeve arranged on the test cylinder, a threaded rod arranged on the threaded sleeve and connected to the spline shaft, and an extruding circular truncated cone arranged on the threaded rod.

9. The apparatus for testing the thermal-state conduction performance of an electrical penetration piece of a high-temperature gas-cooled reactor according to claim 8, wherein the limiting portion comprises a sliding block arranged on the test cylinder, a vertical rod arranged on the sliding block, a reset spring arranged on the vertical rod and connected to the threaded sleeve, a limiting strip arranged on the vertical rod, and an extruding inclined block arranged on the limiting strip and matched with the extruding circular truncated cone.

10. The apparatus for testing the thermal-state conduction performance of an electrical penetration piece of a high-temperature gas-cooled reactor according to claim 9, wherein the testing portion comprises a vacuum pump arranged on the test cylinder, a gas cylinder arranged on the base and connected to the test cylinder, and a constant-temperature control cabinet arranged on the test cylinder.
